(19) United States
(12) Patent Application Publication
(10) Pub. No.: US 2015/0021313 A1
(43) Pub. Date: Jan. 22, 2015

(54) ENERGY-SAVING HEATING PAD

(71) Applicant: Long Huang CHANG, New Taipei City (TW)

(72) Inventor: Long Huang CHANG, New Taipei City (TW)

(21) Appl. No.: 13/943,766

(22) Filed: Jul. 16, 2013

(51) Int. Cl. H05B 3/02

(52) U.S. Cl. CPC H05B 3/02
USPC 219/528

(57) ABSTRACT

The present invention provides an energy-saving heating pad comprising a pad member comprising a heating wire enclosed by at least one heat accumulation layer therein and a socket connected to the heating wire therein; a controller comprising a plug connected to the socket of the pad member and a power outlet plug therein. As the heating wire being enclosed by the heat accumulation layers provided inside the pad member, the user is able to heat up the heating wire for a certain period of time to allow fast heat conduction on the heat accumulation layer for heat accumulation and preservation. Furthermore, it allows portable uses with convenience once it is heated via the electrical plug for a certain period of time, which lessens the safety concern on having the human body being exposed under the electromagnetic waves generated and achieves the merit of being energy-saving altogether.

### TECHNICAL FIELD OF THE INVENTION

The present invention is related to an energy-saving heating pad, in particular, to pad installed with heating wires; in addition, the pad further comprises at least one heat accumulation layer therein; wherein each one of the heat accumulation layer encloses the heating wires such that when a user heats up the heating wire for a certain period of time, the heat accumulation layer is able to achieve the effects of fast heat conduction and heat accumulation for thermal preservation purposes. Furthermore, the present invention can be heated up via an electrical plug for a certain period of time such that when it is unplugged, it is of the merits of excellent portability and convenience for uses while being able to lessen the safety concern associated with the electromagnetic waves and accidental contacts with the bodies and to achieve the objective of being energy-saving.

### DESCRIPTION OF THE PRIOR ART

For a conventional heating blanket, as shown in FIG. 1, it typically comprises an upper cotton layer 10, a lower cotton layer 11 and a controller 12. A heating pipe 121 is provided between the upper cotton layer 10 and the lower cotton layer 11 and is further connected to the controller 12. A user can use the controller 12 to control and adjust the temperature thereof in order to achieve the heating effect of the entire known heating blanket and such that the purpose of heat preservation can be accomplished.

Although such known heating blanket is able to achieve the heating effect of the entire structure, the heating blanket requires the entire structure to be continuously heated in order to achieve the heat accumulation for heat preservation. If the user switches off the power connected to such known heating blanket, the temperature of the blanket would decrease rapidly, which requires the user to reheat the blanket for another extra period of time in order to allow the blanket to reach the desired temperature for heat preservation again; such known blanket is troublesome to the practical uses. In addition, another drawback of such known heating blanket is the requirement of continuous power supply from the electrical plug. As the known blanket is continuously plugged into the electrical plug during its use, electromagnetic waves are generated, which is likely to cause safety hazards to the human body subject to the exposure of the electromagnetic waves generated after a long period of time. Furthermore, the upper cotton layer 10 and the lower cotton layer 11 of such known heating blanket are of unevenly distributed heat due to poor heat conductions thereof; as a result, it can be unsafe for long period of uses as the heat can be accumulated unevenly but concentrated at certain areas causing overheating at these areas and leading to undesirable bum injuries of the user.

### SUMMARY OF THE INVENTION

In view of the drawbacks associated with the known heating blanket in that the heating temperature thereof decrease rapidly due to its heat lost and the requirement for further heating to a certain temperature after an extra period of time to achieve the heat preservation and heat accumulation desired, an objective of the present invention is to provide an energy-saving heating pad. The energy-saving heating pad of the present invention is able to utilize the heating wire disposed inside the pad member thereof and to provide at least one heat accumulation layer inside the pad member, wherein each one of the heat accumulation layers encloses the heating wire, such that when the user heats up the heating wire therein for a certain period of time, the effects of fast heat conduction and heat accumulation as well as heat preservation can be achieved via the heat accumulation layer. Furthermore, the present invention allows portable uses with convenience once it is heated via the electrical plug for a certain period of time, which too lessens the safety concern on having the human body being exposed under the electromagnetic waves generated and achieves the merit and objective of being energy-saving altogether.

To achieve the aforementioned objectives, the present invention provides an energy-saving heating pad, comprising:

a pad member comprising a heating wire disposed therein and at least one heat accumulation layer provided therein; the at least one heat accumulation layer enclosing the heating wire; the pad member further comprising a socket provided therein and connected to the heating wire;

a controller comprising a plug on one end thereof; the plug connected to the socket of the pad member; the controller further comprising a power outlet plug on another end thereof

The energy-saving heating pad provided by the present invention is able to utilize the heating wire disposed inside the pad member and to provide at least one heat accumulation layer inside the pad member, wherein each one of the heat accumulation layers encloses the heating wire, such that when the user heats up the heating wire therein for a certain period of time, the effects of fast heat conduction and heat accumulation as well as heat preservation can be achieved via the heat accumulation layer. Furthermore, the present invention allows portable uses with convenience once it is heated via the electrical plug for a certain period of time, which too lessens the safety concern on having the human body being exposed under the electromagnetic waves generated and achieves the merit and objective of being energy-saving altogether.

### BRIEF DESCRIPTION OF THE DRAWINGS

FIG. 1 is a perspective view of a known heating blanket;

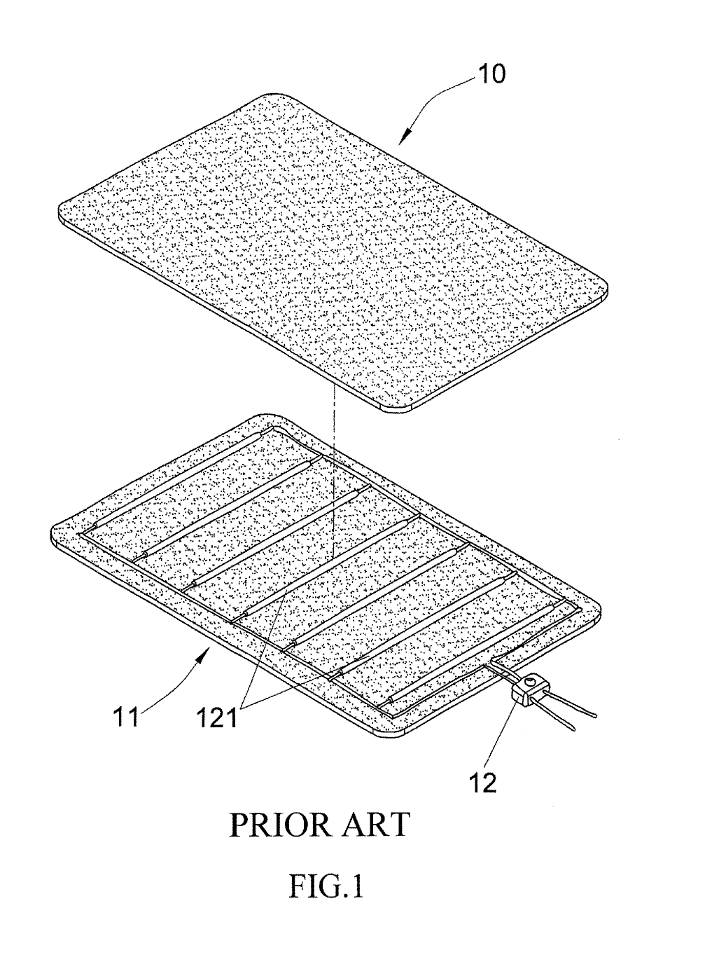

FIG. 2 is a perspective view of the energy-saving heating pad of the present invention;

FIG. 3 is a cross-sectional side view of the present invention;

FIG. 4 is a block diagram of the controller of the present invention; and

FIG. 5 is an illustration showing the heat accumulation and preservation state of the present invention.

### DETAILED DESCRIPTION OF THE PREFERRED EMBODIMENTS

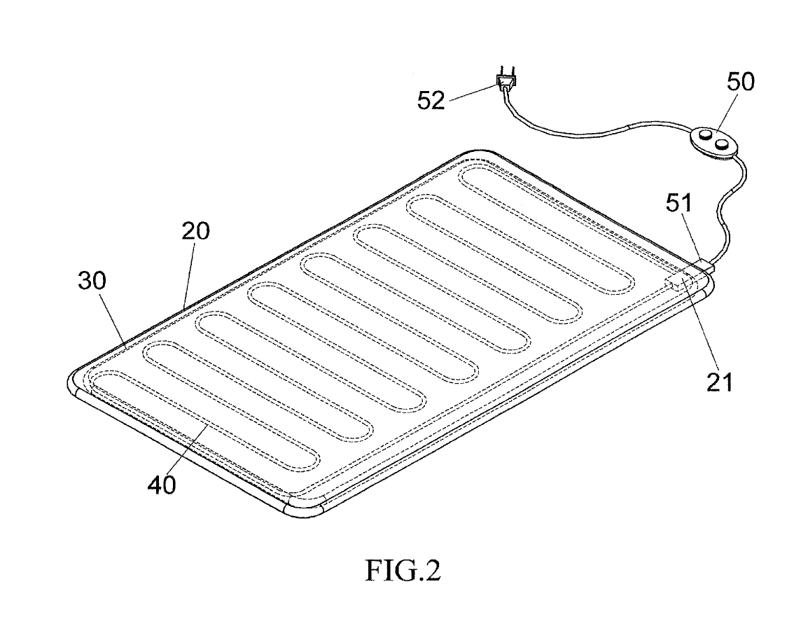

Please refer to FIG. 2. As shown in the figure, the present invention provides an energy-saving pad comprising:

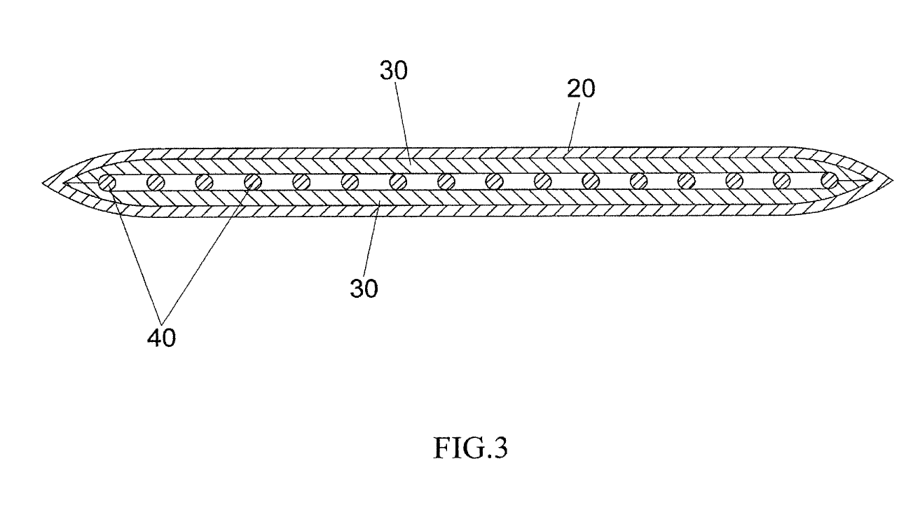

a pad member 20 comprising a heating wire 40 disposed therein and at least one heat accumulation layer 30 provided therein; the at least one heat accumulation layer 30 can be a heat accumulation gel; as shown in FIG. 3, each one of the heat accumulation layers 30 enclosing the heating wire 40; the pad member 20 further comprising a socket 21 provided therein and connected to the heating wire 40;

a controller 50 comprising a plug 51 on one end thereof; the plug 51 connected to the socket 21 of the pad member 20; the controller 50 further comprising a power outlet plug 52 on another end thereof; and the power outlet plug 52 can be coupled to the electricity on grid or common household wall sockets.

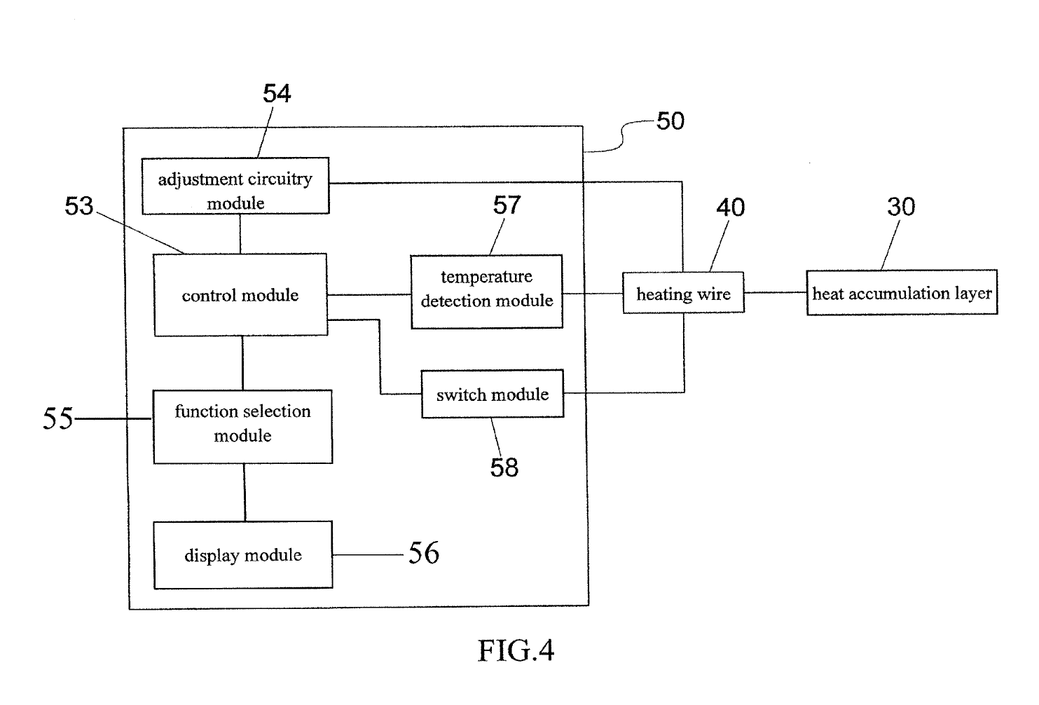

Furthermore, as shown in FIG. 4, the controller 50 further comprises a control module 53, an adjustment circuitry module 54, a temperature detection module 57, a display module 56, a function selection module 55 and a switch module 58 therein; the adjustment circuitry module 54 is electrically connected to the control module 53 on one end thereof and is electrically connected to the heating wire 40 on another end thereof in order to achieve the effect of adjusting the temperature via the adjustment circuitry module 54; the temperature detection module 57 is electrically connected to the control module 53 on one end thereof and is electrically connected to the heating wire 40 on another end thereof in order to achieve the effect of detecting the temperature status of the heating wire 40; the switch module 58 is electrically connected to the control module 53 on one end thereof and is electrically connected to the heating wire 40 on another end thereof in order to achieve the effect of controlling the switch of the power circuit; the function selection module 55 is electrically connected to the control module 53; and the display module 56 is electrically connected to the control module 53 such that the status of the controller 50 can be displayed via the display module 56.

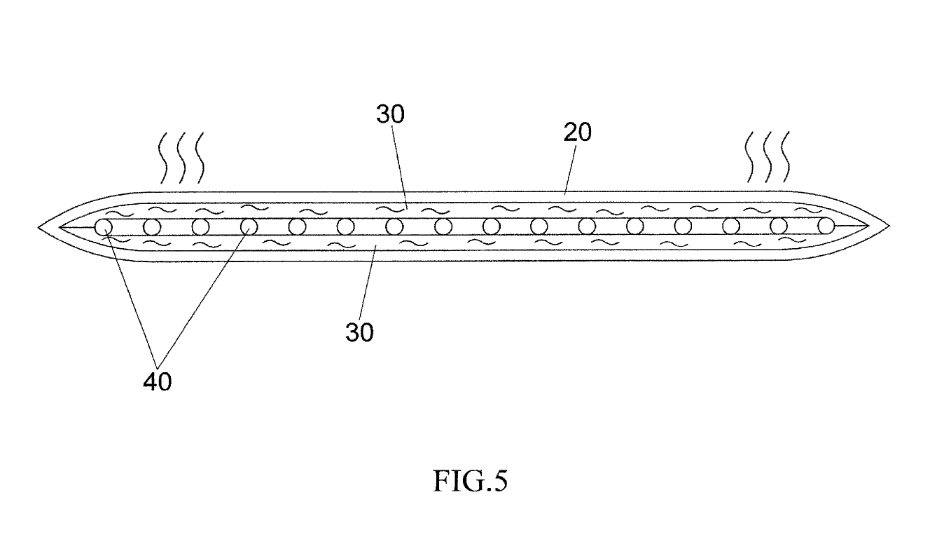

A shown in FIG. 5, since the pad member 20 comprises the heating wire 40 disposed therein and the at least one heat accumulation layer 30 provided therein, once the heating wire 40 is supplied with the electricity from the power outlet plug 52 plugged in by an user, the heating wire 40 can be heated up for a desired period of time; following which, as each one of the heat accumulation layer 30 encloses the heating wire 40, the effect of fast heat conduction throughout the entire pad member 20 can be achieved. If the user decides to switch off the power after a certain temperature is reached in order to stop the heating on the heating wire 40, with the structure having each one of the heat accumulation layer enclosing the heating wire 40, the pad member 20 can still be maintained at a certain temperature for a significant period of time without any electricity for heating such that the effect of heat accumulation and preservation of the pad member 20 can be achieved with the merit of being energy-saving. Furthermore, the present invention can also be pre-heated after being plugged in for heating with the electricity on the heating wire 40 for a certain period of time to allow the heat accumulation layer 30 to act as a heat source with heat accumulation and preservation. As a result, once the plug 51 is removed from the power outlet, it can be used portably with great convenience while being able to lessen the safety concern on having the human body being exposed under the electromagnetic waves generated. In addition, since the heat accumulation layer 30 can be a heat accumulation gel which is capable of achieving the effect of uniform heat conduction in a gel form, the safety hazard of burn injury on the skin of the user due to overheating can be reduced.

What is claimed is:

1. An energy-saving heating pad, comprising:
a pad member comprising a heating wire disposed therein and at least one heat accumulation layer provided therein; said at least one heat accumulation layer enclosing said heating wire; said pad member further comprising a socket provided therein and connected to said heating wire;
a controller comprising a plug on one end thereof; said plug connected to said socket of said pad member; said controller further comprising a power outlet plug on another end thereof.

2. The energy-saving heating pad according to claim 1, wherein said at least one heat accumulation layer is a heat accumulation gel.

3. The energy-saving heating pad according to claim 1, wherein said controller further comprises a control module, an adjustment circuitry module, a temperature detection module, a display module, a function selection module and a switch module therein; said adjustment circuitry module is electrically connected to said control module on one end thereof and is electrically connected to said heating wire on another end thereof;
said temperature detection module is electrically connected to said control module on one end thereof and is electrically connected to said heating wire on another end thereof; said switch module is electrically connected to said control module on one end thereof and is electrically connected to said heating wire on another end thereof; said function selection module is electrically connected to said control module; and said display module is electrically connected to said control module.
